(19) United States
(12) Patent Application Publication
(10) Pub. No.: US 2013/0173374 A1
(43) Pub. Date: Jul. 4, 2013

(54) Application Programming Interface For Determining When A Mobile Device Is Inside A Vehicle

(71) Applicant: Jeffrey Lawrence Weiss, West Palm Beach, FL (US)

(72) Inventor: Jeffrey Lawrence Weiss, West Palm Beach, FL (US)

(21) Appl. No.: 13/552,664

(22) Filed: Jul. 19, 2012

Related U.S. Application Data
(63) Continuation-in-part of application No. 13/448,296, filed on Apr. 16, 2012, now abandoned.
Application No. 13/448,296 is a continuation of application No. 13/306,971, filed on Nov. 29, 2011, now abandoned.
(60) Provisional application No. 61/458,688, filed on Nov. 29, 2010.

(51) Int. Cl. G06Q 30/02

(52) U.S. Cl. 705/14.27

(57) ABSTRACT

A method for determining if a pre-configured set of relevant conditions exist that can be used to suggest a mobile device is within the confines of a vehicle operator compartment or passenger vehicle compartment. Then, an application-programming interface can be used to signal a program when those conditions are meet, and what conditions were involved in that determination.

### CROSS-REFERENCES TO RELATED APPLICATIONS

The present application is a continuation in part of U.S. application Ser. No. 13/448,296 filed Apr. 16, 2012, which is a continuation of U.S. application Ser. No. 13/306,971, filed Nov. 29, 2011, which claims priority from U.S. Provisional Application Ser. No. 61/458,688 filed on Nov. 29, 2010, which are each hereby incorporated herein by reference in their respective entirety.

### TECHNICAL FIELD

The present invention, in some embodiments thereof, relates to mobile communication devices.

### BACKGROUND OF THE INVENTION

The subjection invention addresses the need for determining when a mobile device is located inside a vehicle for providing that information to other useful processes operating on the mobile device.

### BRIEF SUMMARY OF EMBODIMENTS OF THE INVENTION

The present invention determines if a pre-configured set of relevant conditions exist that can be used to suggest a mobile device is within the confines of a vehicle operator compartment or passenger vehicle compartment. The application-programming interface can be used to signal a program when those conditions are meet, and what conditions were involved in that determination.

(1) A computer implemented method operable on a network comprising a server and a mobile communication device, for facilitating fuel conservation and safety in vehicles and advertising by merchants, comprises: determining a user position in a vehicle by checking whether an initial condition exists between the vehicle and a mobile communication device held by a user; measuring and computing route data of the vehicle in motion; communicating the route data to the server over the network; awarding redeemable points to an account associated with the user based on when a predetermined metric of the route data is met; and redeeming the points for products or services at a merchant.

(2) In a variant, the method further comprises determining an operating mode based on the step of determining the user position, wherein the mode is selected from one of: a driver mode, wherein the driver mode is selected if the user position is determined to be that of the driver of the vehicle; and a commuter mode if none of the conditions for the other modes are satisfied and the mobile device is moving faster than a predetermined speed; and awarding a greater number of redeemable points to the account per unit of metric of the route data if the route is carried out in driver mode than in commuter mode.

(3) In another variant of the method, the mode is selected from one of: a driver mode; a commuter mode; and a carpool mode. The carpool mode is selected if a driver mode is selected and a second user mobile communication device is detected within a predetermined radius of a first user mobile communication device in driver mode, both users are moving in the same direction within a predetermined range of speed of each other and an account associated with the second user mobile communication device is selected on the first user mobile communication device. A greater number of redeemable points is awarded to the account, per unit of metric of the route data, if the route is carried out in carpool mode rather than in commuter mode.

(4) In a further variant, the method further comprises the mode being selected from one of: a driver mode; a commuter mode; a carpool mode; and a flight mode. The flight mode is selected if the position of the mobile device moves from a first location to a second location in a time faster than ground transportation is capable of providing. A greater number of redeemable points is awarded to the account, per unit of metric of the route data, if the route is carried out in driver mode rather than in commuter mode.

(5) In still another variant of the method, the step of determining a user position in a vehicle by checking whether an initial condition exists between the vehicle and a mobile communication device held by a user, comprises: checking any of: (i) whether a successful pairing has occurred between the mobile device a the vehicle's blue tooth communication system; (ii) whether the mobile device is engaged with a vehicle docking station; (iii) whether a vehicle multimedia connector is connected to a blue tooth headset and GPS or cellular triangulation detected movement and route recording; (iv) whether the mobile device is connected to a vehicle audio input and a vehicle charging power cord and movement is detected via GPS or cellular triangulation; (v) whether the mobile device is connected to a wired multimedia headset and a charging power cord and movement is detected via GPS or cellular triangulation; (vi) whether the mobile device is connected to a USB multimedia connector and connected to the vehicle's multimedia system USB interface; and (vii) whether the mobile device is connected to a managed communications environment (MCE) signaling system.

(6) In yet a further variant, the method comprises awarding a virtual bumper sticker to the user based on the route traveled.

(7) In another variant of the method, the awarding of points is increased if the mobile device is configured to deny access to a communication application while the mobile device is in driver mode.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 illustrates various associated components for interaction with a mobile device. Either a single component or multiple components are combined to accomplish the desired connection combinations.

FIG. 2 illustrates a combination of a mobile device, GPS signal, and vehicle supplied power.

FIG. 3 illustrates a combination of mobile device, GPS signal, and a Bluetooth hands free speaker phone.

FIG. 4 illustrates a combination of mobile device, GPS signal, and a multi-media cable connection.

FIG. 5 illustrates a combination of mobile device, GPS signal, vehicle supplied power, and a wired headset.

FIG. 6 illustrates a combination of mobile device, GPS signal, and a vehicle docking cradle.

FIG. 7 illustrates a combination of mobile device, GPS signal, vehicle supplied power, and a stereo audio cable.

FIG. 8 illustrates a combination of mobile device, GPS signal, and Bluetooth proximity device.

FIG. 9 illustrates a combination of mobile device, GPS signal, and an Apple Docking Connector.

FIG. 10 illustrates a combination of mobile device, GSP signal, and a vehicle's OEM connector cable.

FIG. 11 illustrates the process of using a Bluetooth device in the vehicle as a proximity sensor.

FIG. 12 illustrates the Apple proprietary docking connector and pin outs.

FIG. 13 illustrates a combination of mobile device, and a signal from a managed communications environment (MCE).

FIG. 14 illustrates two situations, a mobile device and user both outside a room, and a mobile device and user both inside a room equipped with the emitters of a managed communications environment.

FIG. 15 is a flow chart of one embodiment of a method of facilitating fuel conservation and safety in vehicles and advertising by merchants.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The following reference numerals are used throughout this document.

1—The mobile device

2—Vehicle docking station

3—Power cable

4—Wired headset

5—Audio cable

6—USB multimedia cable

7—Vehicle docking connector (Vehicle OEM)

8—Bluetooth proximity paired device

9—Apple dock connector cable for iPhones

10—GPS signal

11—Bluetooth hands free speaker phone

12—MCA signal (managed communications environment)

The present invention, in some embodiments thereof, relates to a method of determining whether a mobile device is within the confines of a vehicle operator compartment or passenger vehicle compartment. The devices that connect to the mobile device do so with a variety of wired and wireless connections and signals. Several unique combinations of these connections are indicative of being inside a vehicle. Described immediately below are examples of various combinations of those conditions that are commonly used when a person is inside the vehicle operator compartment a vehicle under his or her control.

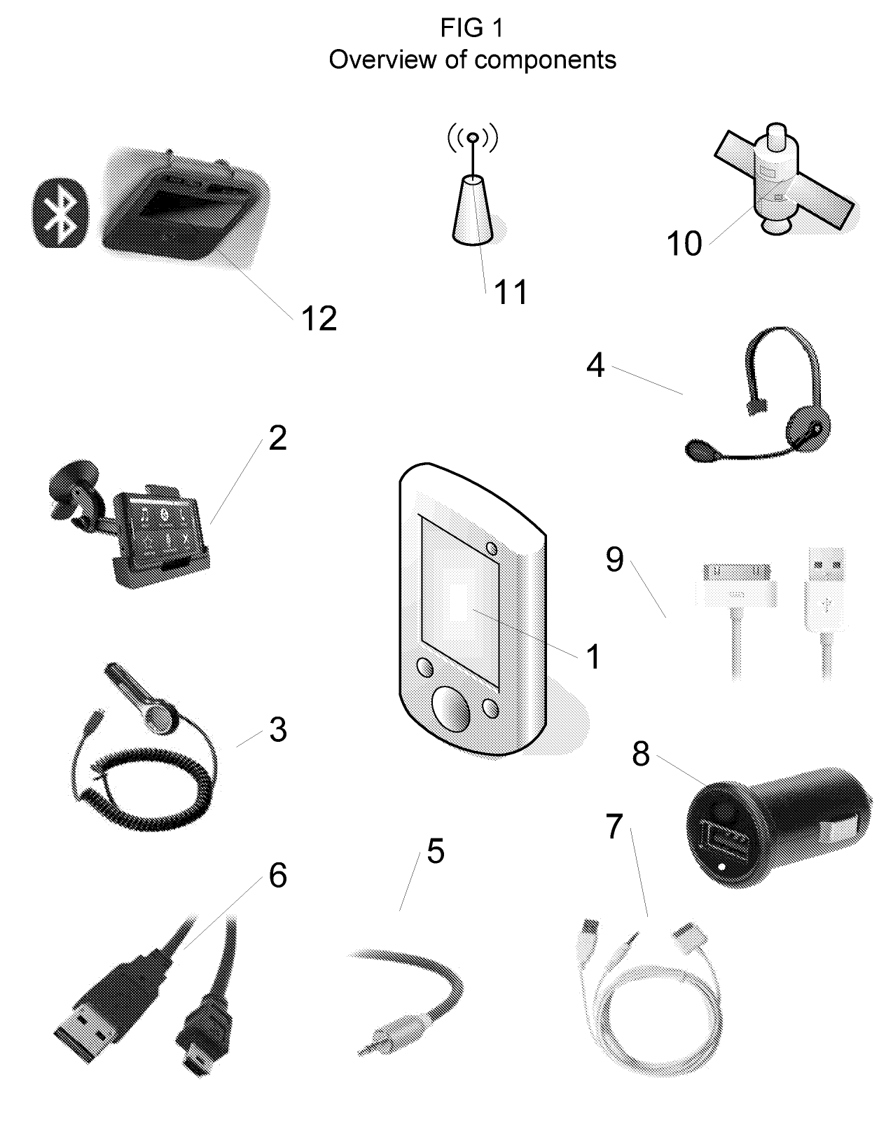

FIG. 1 illustrates various associated components for interaction with a mobile device. Either a single component or multiple components are combined to accomplish the desired connection combinations.

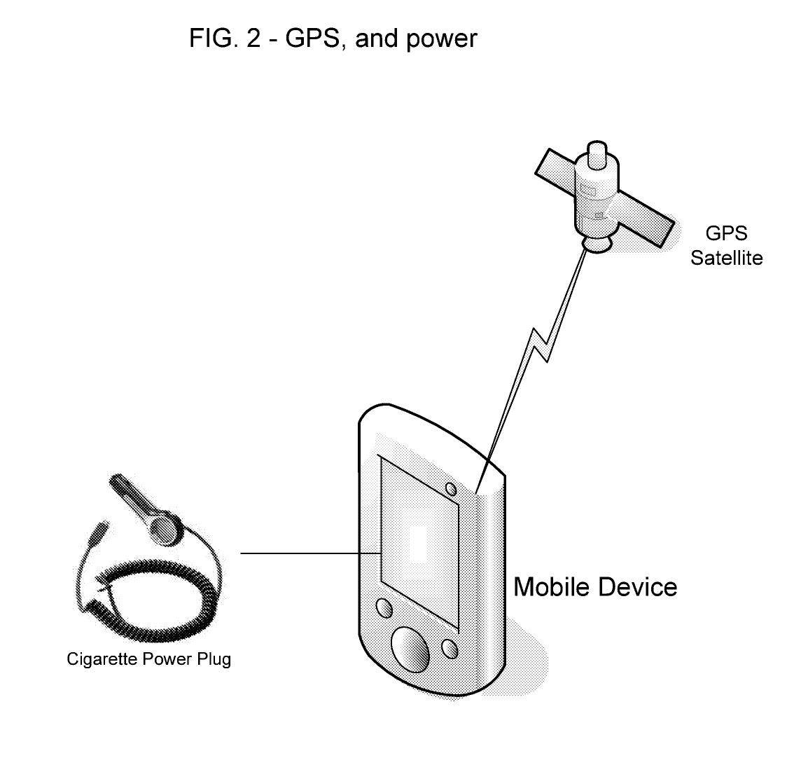

FIG. 2 illustrates a combination of a mobile device 1, GPS signal 10, and vehicle supplied power 3.

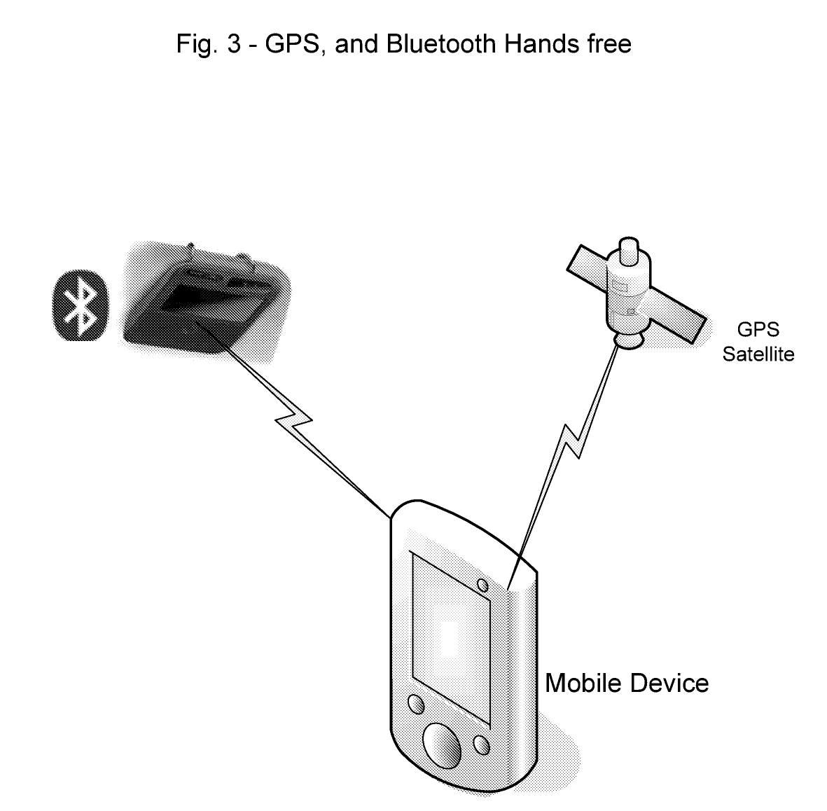

FIG. 3 illustrates a combination of mobile device, GPS signal, and a Bluetooth hands free speaker phone. The speaker phone can be either an aftermarket device or a vehicle's factory installed Bluetooth system.

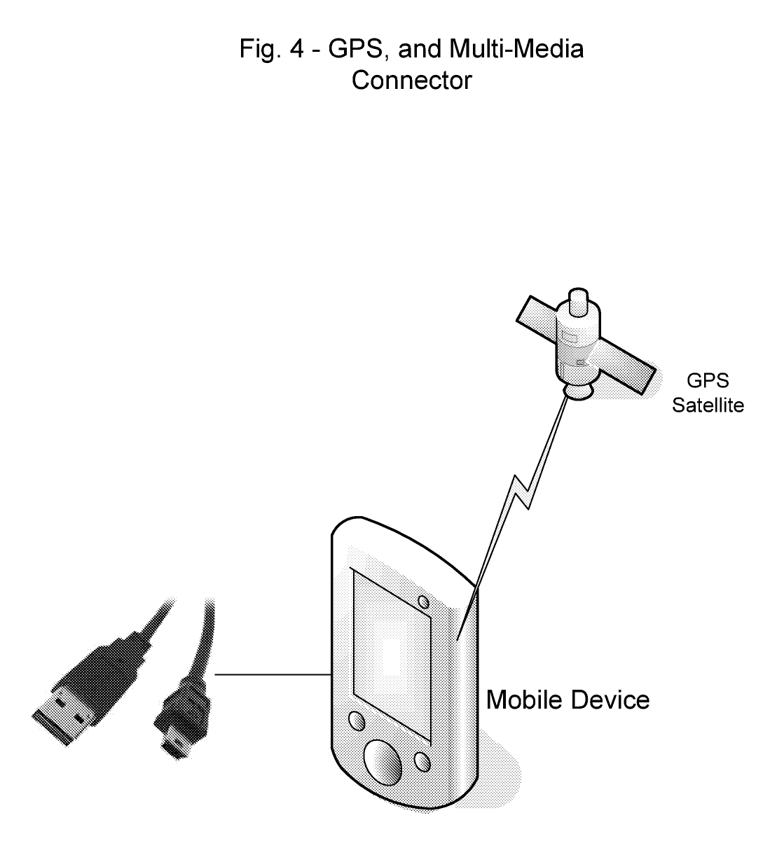

FIG. 4 illustrates a combination of mobile device, GPS signal, and a multi-media cable connection. The multi-media cable can provide the mobile device with information that can suggest it is connected to a vehicle's audio or video system.

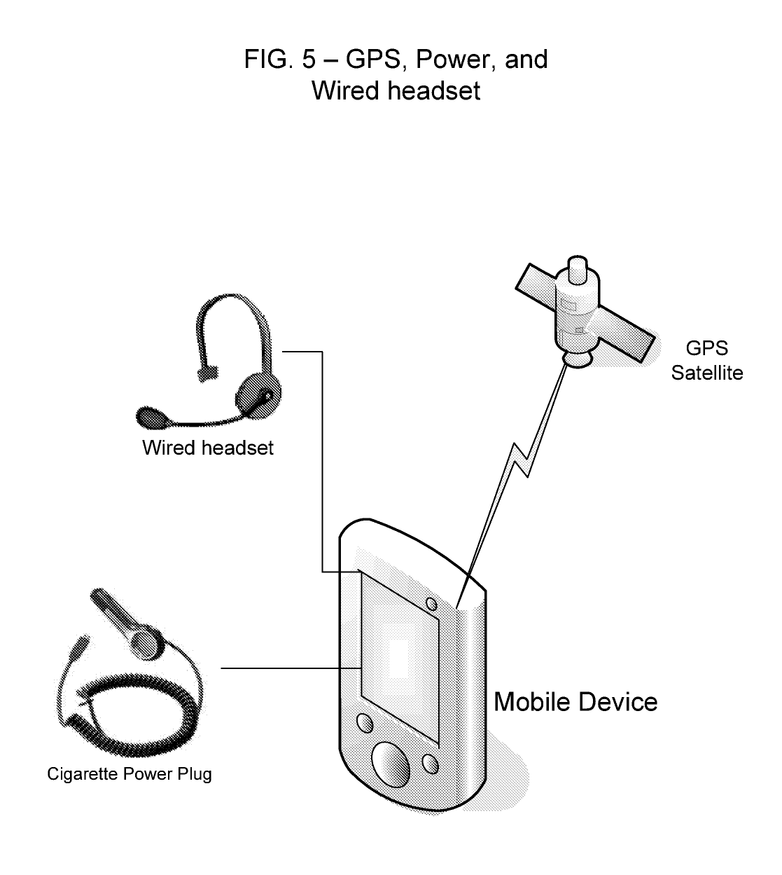

FIG. 5 illustrates a combination of mobile device, GPS signal, vehicle supplied power, and a wired headset.

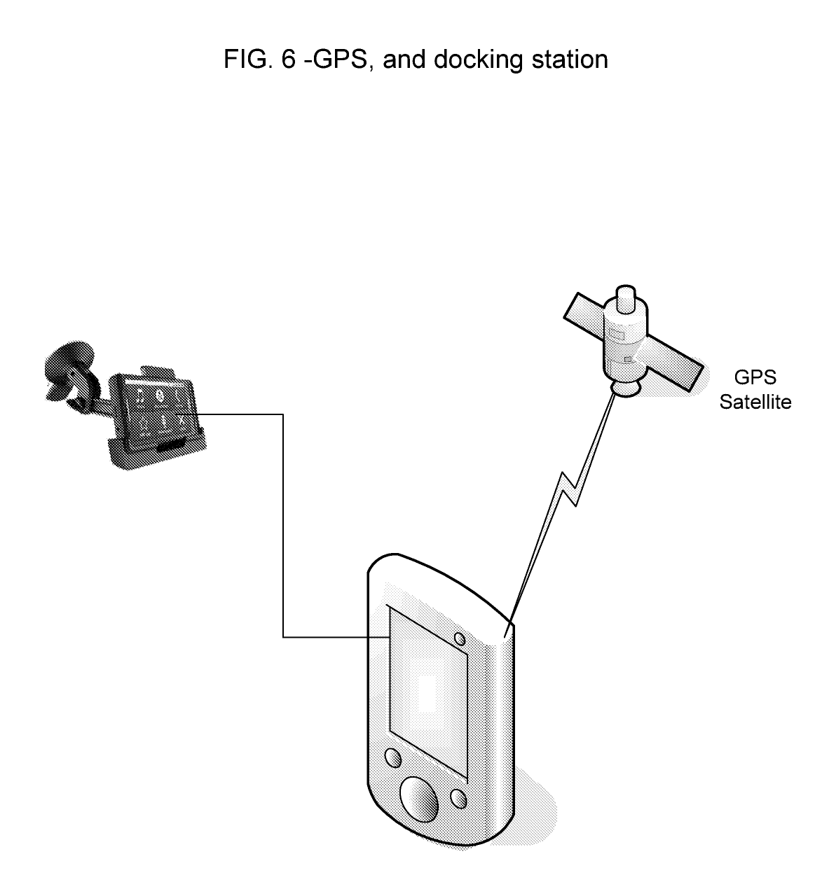

FIG. 6 illustrates a combination of mobile device, GPS signal, and a vehicle docking cradle. The cradle typically can provide power, and connection to the vehicle's audio system via a cable or Bluetooth.

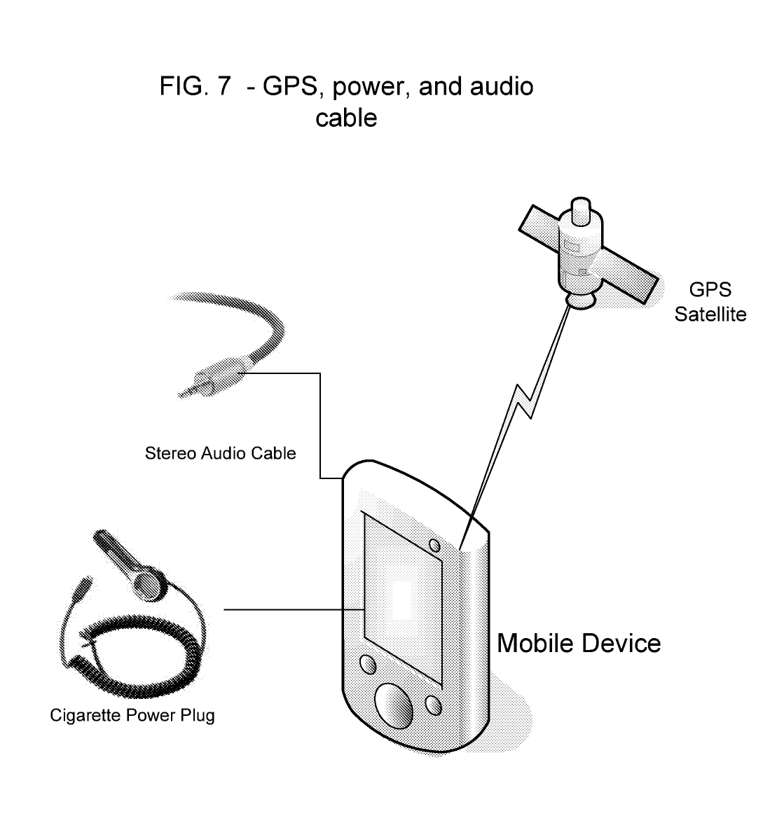

FIG. 7 illustrates a combination of mobile device, GPS signal, vehicle supplied power, and a stereo audio cable. The stereo audio cable is typically connected to the vehicle's audio system via a dedicated input jack.

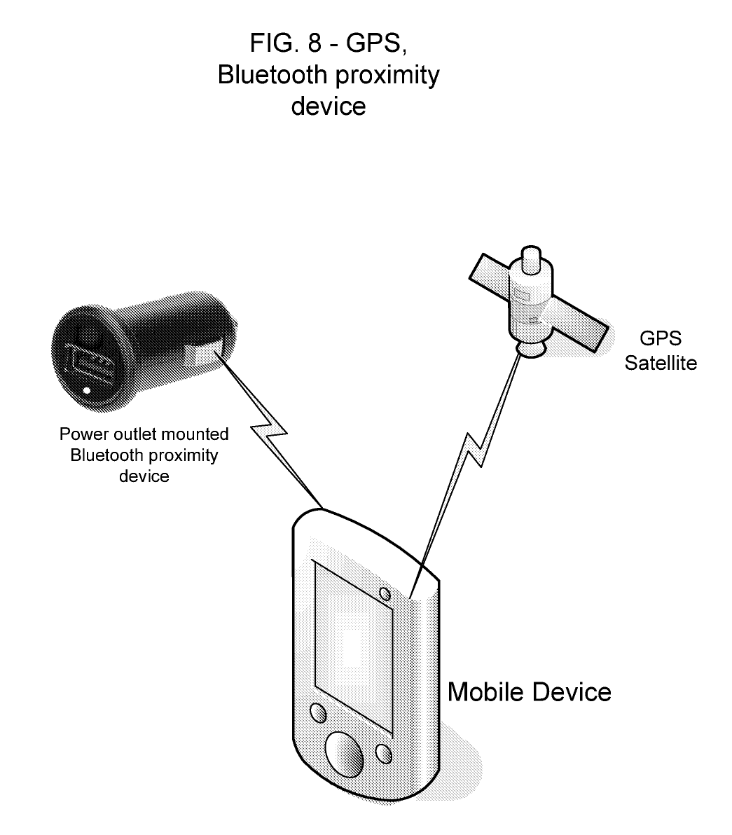

FIG. 8 illustrates a combination of mobile device, GPS signal, and Bluetooth proximity device. The Bluetooth proximity device is any Bluetooth device that is paired with the mobile device for the dedicated purpose of signaling when the mobile device is inside the vehicle.

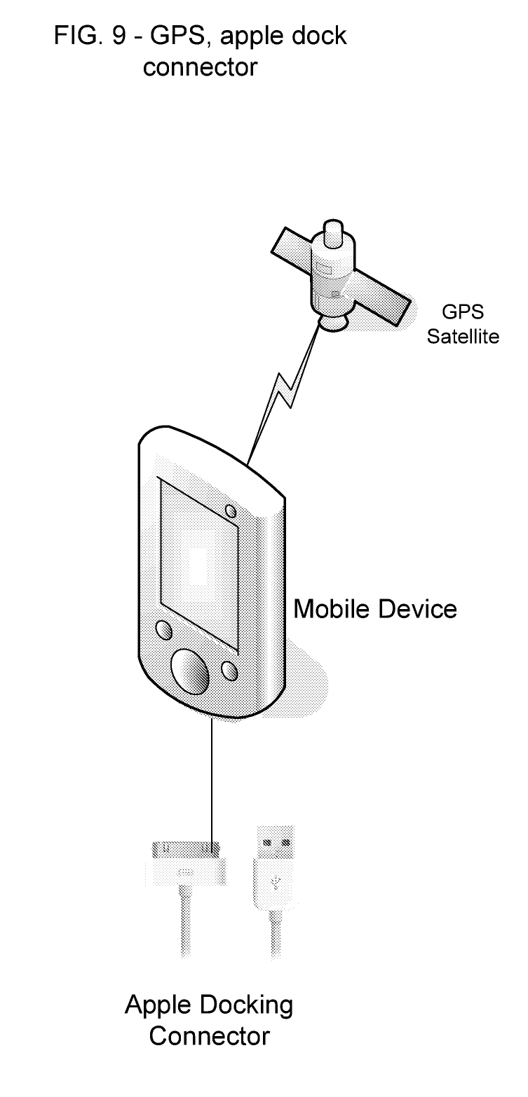

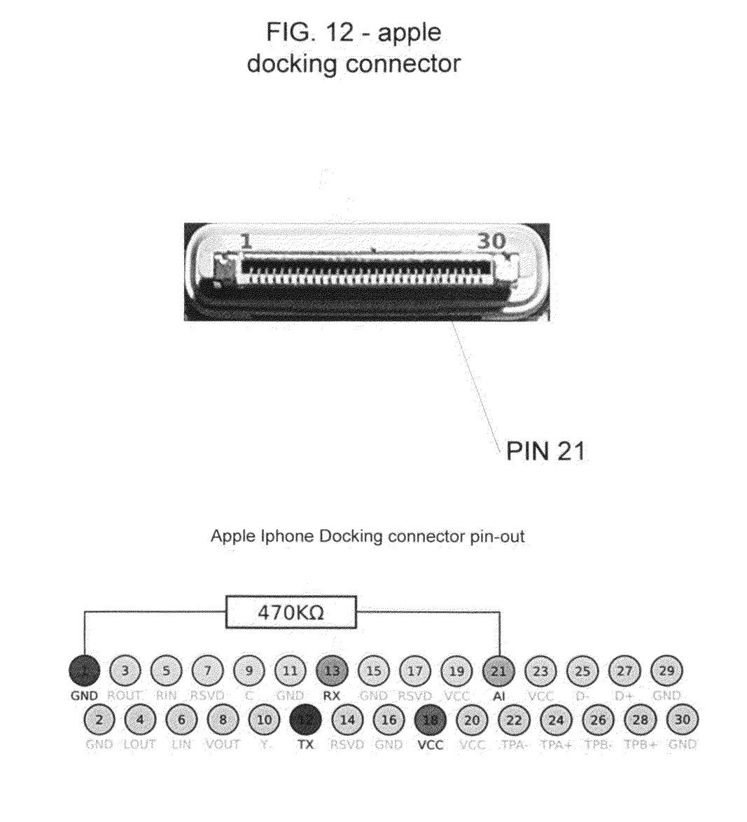

FIG. 9 illustrates a combination of mobile device, GPS signal, and an Apple Docking Connector. The docking connector (FIG. 12 has) has a dedicated pin (PIN-21) that informs the Apple devices operating system the type of device or cable the Apple device is connected too. The pin uses predetermined resistance loads to determine the device connected.

For example different resistances indicate accessory type:

1 KOhm—iPod docking station, beeps when connected

10 KOhm—Takes some iPods into photo import mode

68 kOhm—makes iPhone 3 g send audio through line-out without any messages

500 KOhm—related to serial communication/used to enable serial communications Used in Dension Ice Link Plus car interface

1 MOhm—Belkin auto adaptor, iPod shuts down automatically when power disconnected Connecting pin 21 to ground with a 1 MOhm resistor does stop the ipod when power (i.e. Firewire-12V) is cut. When this pin is grounded, it closes a switch so that on loss of power an Ipod shuts off. The dock has the same resistor.

The determination of “in-vehicle” has not been established by Apple Inc. at this time but is expected to be available in future hardware and software releases.

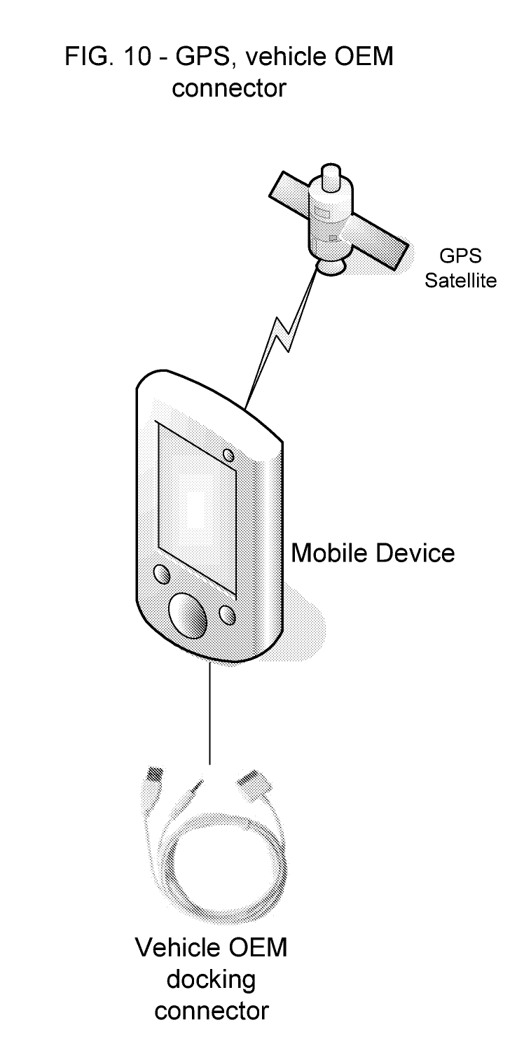

FIG. 10 illustrates a combination of mobile device, GSP signal, and a vehicle's OEM connector cable. This cable can be for a variety of mobile devices including the Apple iphone and devices under the iphone's connection.

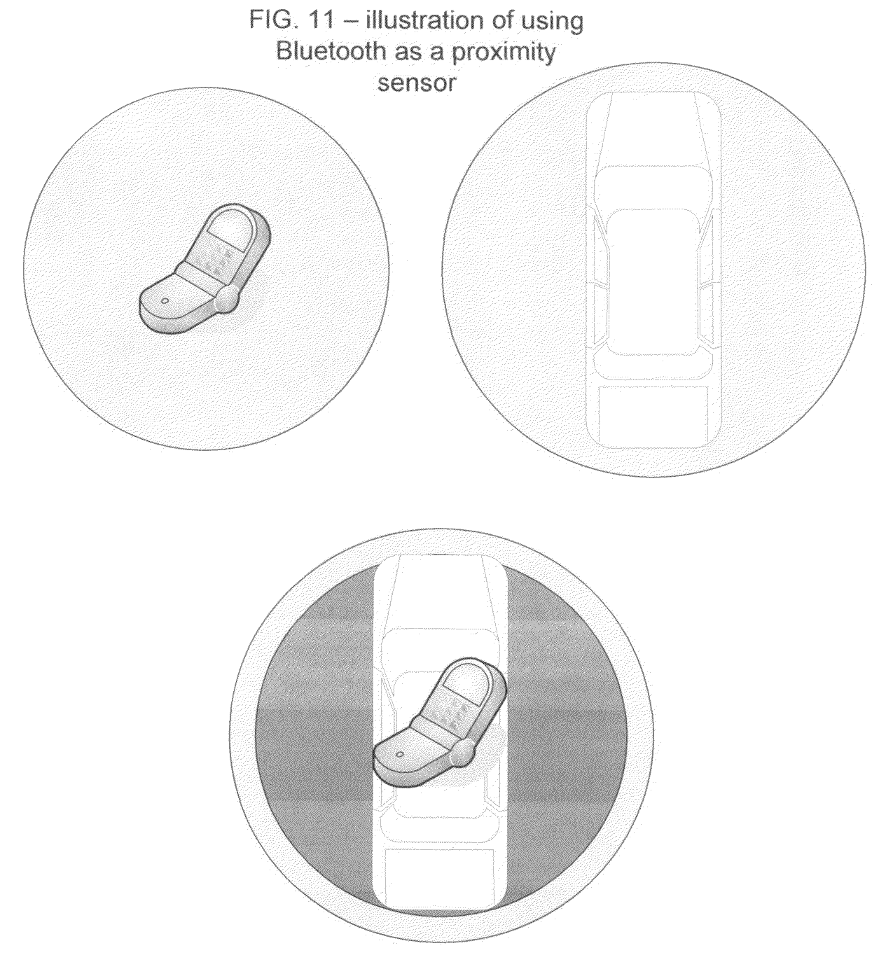

FIG. 11 illustrates the process of using a Bluetooth device in the vehicle as a proximity sensor. Once the two devices are in Bluetooth range, the pairing of the two devices will trigger the API into acknowledging the device in now inside the vehicle.

FIG. 12 illustrates the Apple proprietary docking connector and pin outs. The connector's resistive pin out communicates to the apple device what kind of device it is connected too.

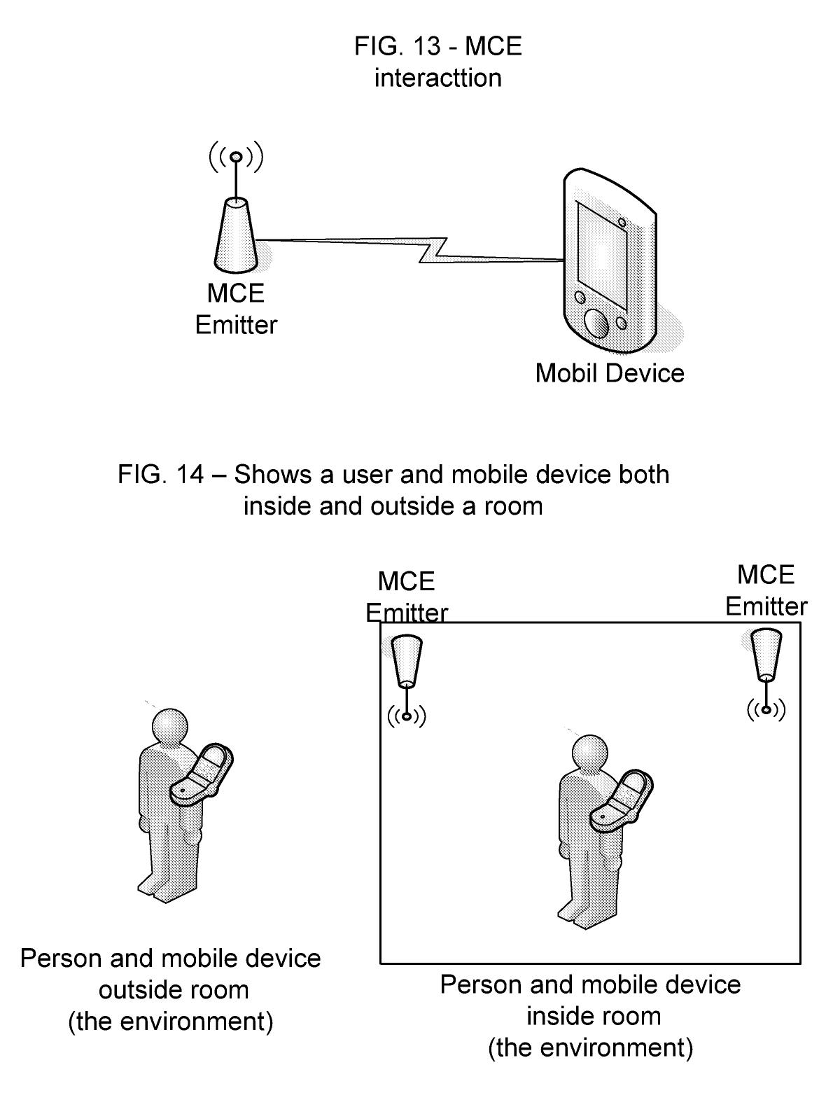

FIG. 13 illustrates a combination of mobile device, and a signal from a managed communications environment (MCE). The MCE is a proprietary technology that can signal a mobile device when it is inside a predetermined physical area or environment.

FIG. 14 illustrates two situations: a mobile device and user both outside a room; and a mobile device and user both inside a room equipped with the emitters of a managed communications environment. This enables the mobile device to be signaled and then services like permitted communications, shopping, concierge services, and person location identification may be carried out. When a mobile device leaves the environment, the services or permitted communications instructions are removed and the mobile device returns to normal operation.

Operation

When each set of conditions are meet in FIGS. 1-14, and the API detects these conditions are valid, an application operating on a mobile device in accordance with the principles of the invention signals a host application that the mobile device is inside a vehicle. The application can then execute instructions, processes, communications or other features that are dependent on these sets of conditions to exist to operate properly.

For example, an anti-texting application will need to know when the driver is in a car and the car is moving. A geo-location game can use this signaling process to validate the mobile device is inside a personal automobile and not commuter train.

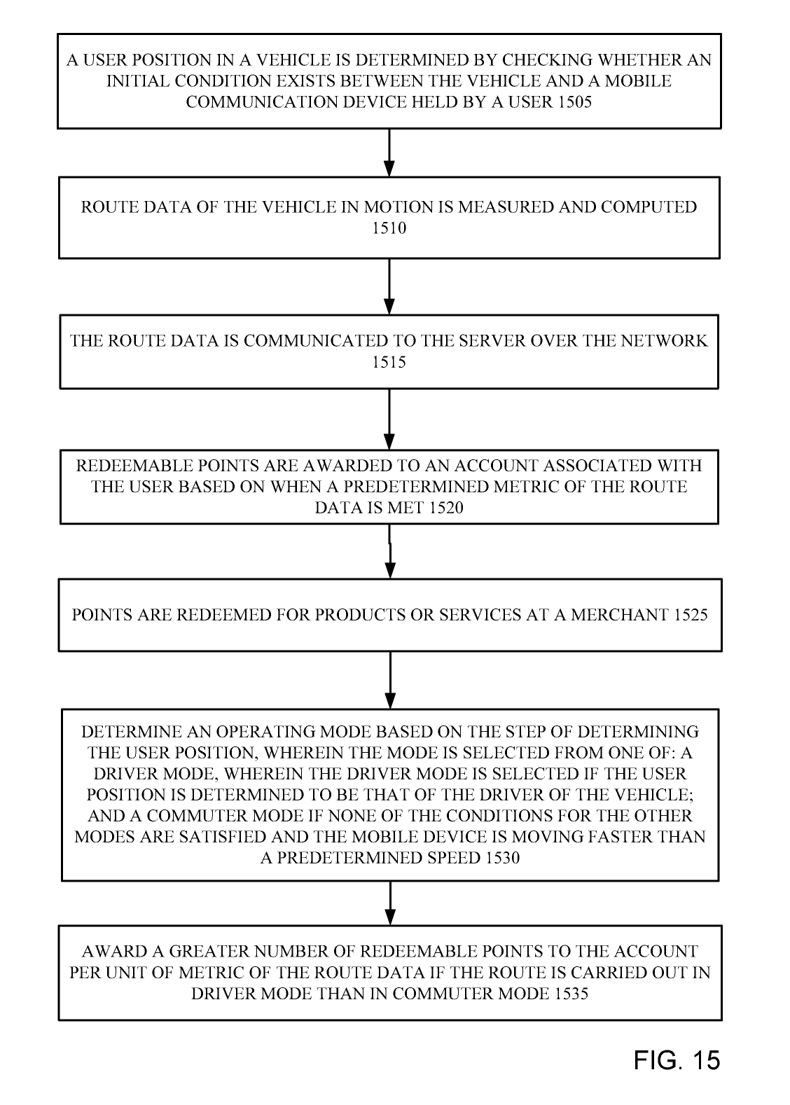

(1) In a variant, referring to FIG. 15, a computer implemented method 1500 operable on a network comprising a server and a mobile communication device, for facilitating fuel conservation and safety in vehicles and advertising by merchants, comprises the following. In a step 1505, a user position in a vehicle is determined by checking whether an initial condition exists between the vehicle and a mobile communication device held by a user. In a step 1510, route data of the vehicle in motion is measured and computed. In a step 1515, the route data is communicated to the server over the network. In a step 1520, redeemable points are awarded to an account associated with the user based on when a predetermined metric of the route data is met. In a step 1525, the points are redeemed for products or services at a merchant.

(2) In a variant, the method further comprises: determining 1530 an operating mode based on the step of determining the user position. The operating mode is selected from one of: a driver mode and a commuter mode. The driver mode is selected if the user position is determined to be that of the driver of the vehicle. and a commuter mode is selected if none of the conditions for the other modes are satisfied and the mobile device is moving faster than a predetermined speed. In a step 1535, the method comprises awarding greater number of redeemable points to the account per unit of metric of the route data if the route is carried out in driver mode than in commuter mode.

(3) In another variant of the method, the mode is selected from one of: a driver mode; a commuter mode; and a carpool mode. The carpool mode is selected if a driver mode is selected and a second user mobile communication device is detected within a predetermined radius of a first user mobile communication device in driver mode, both users are moving in the same direction within a predetermined range of speed of each other and an account associated with the second user mobile communication device is selected on the first user mobile communication device. A greater number of redeemable points is awarded to the account, per unit of metric of the route data, if the route is carried out in carpool mode rather than in commuter mode.

(4) In a further variant, the method further comprises the mode being selected from one of: a driver mode; a commuter mode; a carpool mode; and a flight mode. The flight mode is selected if the position of the mobile device moves from a first location to a second location in a time faster than ground transportation is capable of providing. A greater number of redeemable points is awarded to the account, per unit of metric of the route data, if the route is carried out in driver mode rather than in commuter mode.

(5) In still another variant of the method, the step of determining a user position in a vehicle by checking whether an initial condition exists between the vehicle and a mobile communication device held by a user, comprises: checking any of: (i) whether a successful pairing has occurred between the mobile device a the vehicle's blue tooth communication system; (ii) whether the mobile device is engaged with a vehicle docking station; (iii) whether a vehicle multimedia connector is connected to a blue tooth headset and GPS or cellular triangulation detected movement and route recording; (iv) whether the mobile device is connected to a vehicle audio input and a vehicle charging power cord and movement is detected via GPS or cellular triangulation; (v) whether the mobile device is connected to a wired multimedia headset and a charging power cord and movement is detected via GPS or cellular triangulation; (vi) whether the mobile device is connected to a USB multimedia connector and connected to the vehicle's multimedia system USB interface; and (vii) whether the mobile device is connected to a managed communications environment (MCE) signaling system.

(6) In yet a further variant, the method comprises awarding a virtual bumper sticker to the user based on the route traveled.

(7) In another variant of the method, the awarding of points is increased if the mobile device is configured to deny access to a communication application while the mobile device is in driver mode.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer implemented method operable on a network comprising a server and a mobile communication device, for facilitating fuel conservation and safety in vehicles and advertising by merchants, comprising:
determining a user position in a vehicle by checking whether an initial condition exists between the vehicle and a mobile communication device held by a user;
measuring and computing route data of the vehicle in motion;
communicating the route data to the server over the network;
awarding redeemable points to an account associated with the user based on when a predetermined metric of the route data is met; and
redeeming the points for products or services at a merchant.

2. The method of claim 1, further comprising determining an operating mode based on the step of determining the user position, wherein the mode is selected from one of:
a driver mode, wherein the driver mode is selected if the user position is determined to be that of the driver of the vehicle; and
a commuter mode if none of the conditions for the other modes are satisfied and the mobile device is moving faster than a predetermined speed; and
awarding a greater number of redeemable points to the account per unit of metric of the route data if the route is carried out in driver mode than in commuter mode.

3. The method of claim 2, wherein the mode is selected from one of:
a driver mode;
a commuter mode; and
a carpool mode, wherein the carpool mode is selected if a driver mode is selected and a second user mobile communication device is detected within a predetermined radius of a first user mobile communication device in driver mode, both users are moving in the same direction within a predetermined range of speed of each other and an account associated with the second user mobile communication device is selected on the first user mobile communication device; and
a greater number of redeemable points is awarded to the account per unit of metric of the route data if the route is carried out in carpool mode rather than in commuter mode.

4. The method of claim 3, further comprising:
wherein the mode is selected from one of:
a driver mode;
a commuter mode;
a carpool mode; and
a flight mode, wherein flight mode is selected if the position of the mobile device moves from a first location to a second location in a time faster than ground transportation is capable of providing; and
awarding a greater number of redeemable points to the account, per unit of metric of the route data, if the route is carried out in driver mode rather than in commuter mode.

5. The method of claim 2, wherein the step of determining a user position in a vehicle by checking whether an initial condition exists between the vehicle and a mobile communication device held by a user, comprises:
checking any of:
(i) whether a successful pairing has occurred between the mobile device a the vehicle's blue tooth communication system;
(ii) whether the mobile device is engaged with a vehicle docking station;
(iii) whether a vehicle multimedia connector is connected to a blue tooth headset and GPS or cellular triangulation detected movement and route recording;
(iv) whether the mobile device is connected to a vehicle audio input and a vehicle charging power cord and movement is detected via GPS or cellular triangulation;
(v) whether the mobile device is connected to a wired multimedia headset and a charging power cord and movement is detected via GPS or cellular triangulation;
(vi) whether the mobile device is connected to a USB multimedia connector and connected to the vehicle's multimedia system USB interface;
(vii) whether the mobile device is connected to a managed communications environment (MCE) signaling system.

6. The method of claim 5, further comprising awarding a virtual bumper sticker to the user based on the route traveled.

7. The method of claim 6, wherein the awarding of points is increased if the mobile device is configured to deny access to a communication application while the mobile device is in driver mode.
